(19) United States
(12) Patent Application Publication
(10) Pub. No.: US 2015/0219196 A1
(43) Pub. Date: Aug. 6, 2015

(54) DAMPER COVER PLATE CONNECTION WITH PRESS FIT RIVETING

(71) Applicant: SCHAEFFLER TECHNOLOGIES AG & CO. KG, Herzogenaurach (DE)

(72) Inventors: Thomas Heck, Wooster, OH (US); Markus Steinberger, Macedonia, OH (US)

(73) Assignee: SCHAEFFLER TECHNOLOGIES AG & CO. KG, Herzogenaurach (DE)

(21) Appl. No.: 14/606,269

(22) Filed: Jan. 27, 2015

Related U.S. Application Data
(60) Provisional application No. 61/936,544, filed on Feb. 6, 2014.

(51) Int. Cl. F16H 41/28; B21J 15/02; F16H 45/02

(52) U.S. Cl. CPC F16H 41/28; F16H 45/02; B21J 15/02; F16H 2045/007

(57) ABSTRACT

A damper assembly for a torque converter comprising: a cover plate comprising a hole having a first diameter; a press fit rivet disposed in the hole, the rivet including: a rivet head and a press fit portion having a second diameter; where prior to press fitting the rivet into the hole, the second diameter is greater than the first diameter. A method for connecting a damper assembly and a turbine for a torque converter is also provided.

### FIELD

The invention relates generally to a damper cover plate connection in a torque converter, and more specifically to a damper cover plate connection with press fit riveting.

### BACKGROUND

U.S. Patent Publication No. 2011/0088992 hereby incorporated by reference herein, describes a clutch assembly including a rivet having a head disposed between a leaf spring and a cover with a shaft in the piston plate hole. The piston plate or the cover is deflectable to clamp the rivet head between the cover and the piston plate before the shaft is expanded.

U.S. Pat. No. 8,328,647, hereby incorporated by reference herein, describes a cover or piston plate having leaf spring connections with gripping segments where the cover or piston plate is deflectable and a portion of the connection may include a rivet.

To assemble a torque converter it is known to use conventional rivets as a means of connection for components such as the damper assembly and the turbine. Prior methods of assembly require sufficient access through the damper plate to perform the upsetting operation. The access holes are required to accommodate the riveting tool punch size, clearance to stripper, stripper size, and clearance to damper. To accommodate this reduces the degrees of freedom for positioning and size of the damper springs, thereby, adversely affecting damper rate.

Press fit rivets are not known to be used in torque converters, especially between a damper cover plate and a turbine.

### BRIEF SUMMARY

Example aspects broadly comprise a damper assembly for a torque converter comprising: a cover plate comprising a hole having a first diameter; a press fit rivet disposed in the hole, the rivet including: a rivet head and a press fit portion having a second diameter; where prior to press fitting the rivet into the hole, the second diameter is greater than the first diameter. In an example aspect, the damper assembly includes a flange having an access hole aligned with the rivet head. In an example aspect, the cover plate includes an inner surface facing the flange and an outer surface opposite the inner surface, and wherein the rivet head is disposed at the inner surface.

Other example aspects broadly comprise a torque converter comprising the damper assembly as described and a turbine having a turbine shell, wherein the rivet connects the cover plate and the turbine shell. In an example aspect, the torque converter further comprises a turbine hub, wherein the rivet connects the cover plate, the turbine shell, and the turbine hub.

Other example aspects broadly comprise a torque converter comprising: a turbine including a shell having a first hole and a first diameter; a damper assembly including: a flange including an access hole; a cover plate disposed between the turbine shell and the flange; the cover plate comprising a thickness and a second hole with a second diameter; and, a press fit rivet including: a preformed head aligned with the flange access hole; a press fit portion extending from the preformed head and disposed in the cover plate second hole, the press fit portion having a third diameter equal to the second diameter and a length at most equal to the cover plate thickness; a body portion installed in the first hole and having a fourth diameter equal to the first diameter and at most equal to the second diameter; and, an upset portion disposed at a distal end of the press fit rivet opposite the preformed head and having a fifth diameter larger than the fourth diameter. In an example aspect, the damper cover plate includes an inner surface and an outer surface, and wherein the rivet head is disposed at the inner surface. In an example aspect, the rivet connects the cover plate and the turbine shell. In an example aspect, the torque converter further comprises a turbine hub, wherein the rivet connects the cover plate, the turbine shell, and the turbine hub. In an example aspect, the torque converter includes, prior to press fitting the rivet into the hole, the upset portion has a diameter at most equal to the second diameter.

Other example aspects broadly comprise a method of connecting a damper assembly and a turbine for a torque converter comprising: providing a press fit rivet having: a rivet head, a press fit portion having a first diameter, a body portion having a second diameter, where the second diameter is at most equal to the first diameter; an upset portion, and an opposite end; providing a damper assembly including a cover plate having a hole having a third diameter, where the third diameter is less than the first diameter; press fitting the press fit portion of the rivet into the hole; providing a turbine including a turbine shell having a positioning hole having a fourth diameter; where the fourth diameter is at least equal to or greater than the second diameter; aligning and assembling the positioning hole of the turbine shell onto the rivet; and expanding the upset portion of the rivet into the positioning hole by upsetting the opposite end of the rivet.

In an example aspect, the method includes where the damper assembly further includes a flange having an access hole, and the step of providing a damper assembly further includes aligning the flange access hole with the rivet head. In an example aspect the method includes where the cover plate includes an inner surface and an outer surface, and wherein the rivet head is disposed at the inner surface. In an example aspect, the method includes where the step of aligning and assembling further comprises providing a turbine hub having an opening, and aligning and positioning the opening of the turbine hub onto the rivet prior to the step of expanding. In an example aspect, the method includes where the step of expanding the upset portion of the rivet includes providing upsetting punch and stripper tools and positioning the upsetting tools over the opposite end of the rivet prior to upsetting. In an example aspect, the method includes where the step of providing a damper assembly further includes assembling the damper assembly including springs, radially outward springs, the damper flange, the damper cover plate, and outer sheet metal rivets.

### BRIEF DESCRIPTION OF THE DRAWINGS

The nature and mode of operation of the present invention will now be more fully described in the following detailed description of the invention taken with the accompanying drawing figures, in which:

FIG. 1 illustrates a cross sectional side view of a torque converter including press fit rivet according to an example aspect.

FIG. 2 illustrates a press fit rivet according to an example aspect.

FIG. 3A illustrates a partial cross section side view of a torque converter showing the press fit rivet after press fitting according to an example aspect.

FIG. 3B illustrates a partial cross section side view of a torque converter showing the press fit rivet after upsetting according to an example aspect.

FIG. 4A illustrates an expanded cross sectional side view of a torque converter including a damper assembly showing the press fit rivet after press fitting according to an example aspect.

FIG. 4B illustrates an expanded cross sectional side view of a torque converter showing the press fit rivet after upsetting according to an example aspect.

FIG. 5A illustrates a cross sectional side view of a conventional rivet in a torque converter according to the prior art, upsetting tools shown.

FIG. 5B illustrates a cross sectional side view of a conventional rivet in a torque converter according to the prior art, flange access hole in view.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

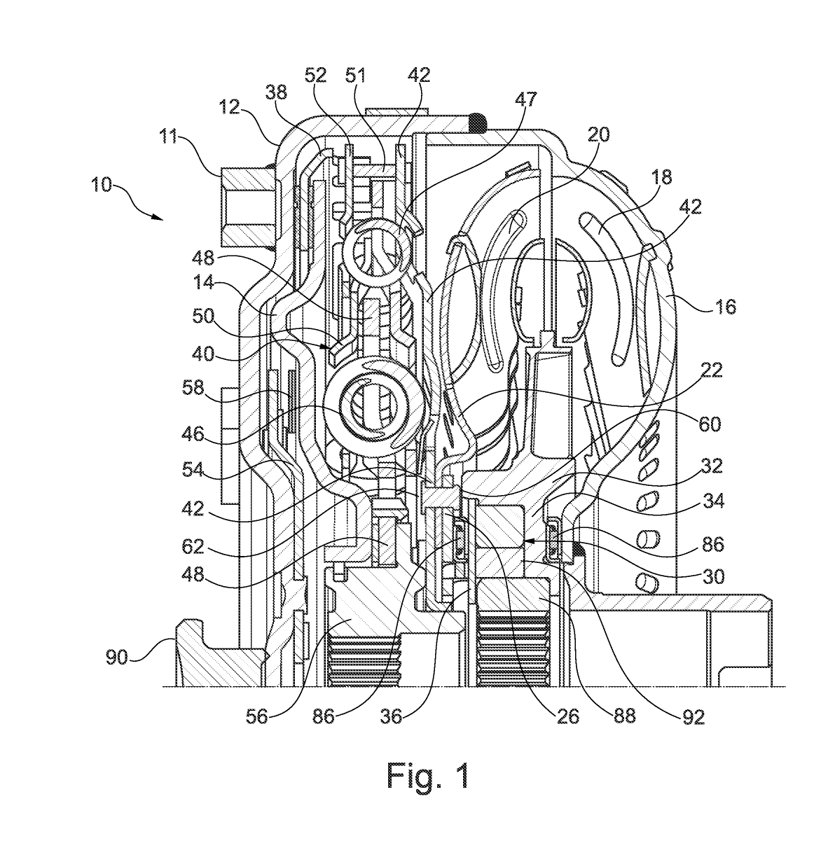

The following description is made with reference to FIGS. 1-4. FIG. 1 illustrates a cross sectional side view of a torque converter including press fit rivet according to an example aspect. Torque converter 10 includes a front cover 12 for connecting to a crankshaft of an internal combustion engine via stud 11 and a rear cover 16, also referred to as impeller shell interchangeably herein, for an impeller 18. Impellers are also referred to in the art interchangeably as ‘pump’. Torque converter 10 also includes turbine 20, turbine shell 22, and turbine hub 26. Torque converter 10 also includes stator 32 between turbine 20 and impeller 18 and a one-way clutch 30 supporting stator 32. A side plate 36 holds one-way clutch 30 in place within stator 32. Stator 32 includes stator base 34.

Torque converter 10 includes piston 14, clutch plate 38, drive plate 54, and cover plates 42, 50, and 52. Outer sheet metal rivet 51 connects cover plates 42 and 52. Leaf springs 58 connect drive plate 54 and piston 14. Torque converter 10 further includes damper hub 56 and damper assembly 40 including cover plate 42, springs 46, radially outward springs 47, flange 48, and press fit rivet 60. Damper assembly 40 is connected to and drivable by turbine 20, and is positioned between turbine 20 and front cover 12. Damper assembly 40 may be advantageously preassembled to include press fit rivet 60. In a particular aspect, rivet 60 is press fit to connect to damper cover plate 42. Rivet 60 further connects damper assembly 40 to turbine shell 22 and turbine hub 26. Press fit rivet 60 is positioned so that the preformed head 62 of rivet 60 is toward the damper. In the prior art, conventional riveting is employed wherein the rivet head is disposed toward the turbine to ease installation of the rivet. That is, it is easier to install the rivet from the turbine side than to guide the rivet through the damper flange. Thus, the prior art requires access through the damper assembly to accommodate upsetting tooling and operation. Torque converter 10 further includes bearings 86, inner race 88, and roller 92 for one-way clutch 30. Cover pilot 90 is shown in FIG. 1; transmission components stator shaft and support shaft are not illustrated.

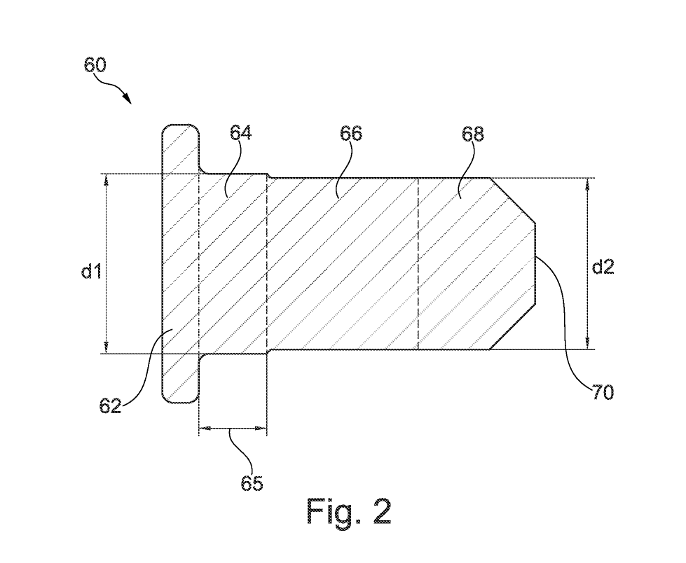

Press fit rivet 60, in an example aspect, is shown in greater detail in FIG. 2. Rivets may be referred to herein as fasteners or connectors. Press fit rivet 60, also referred to herein as simply ‘rivet’, includes head portion 62, press fit portion 64, body portion 66, upset portion 68, and opposite end 70. Head portion 62 may also be referred to as ‘preformed head’ interchangeably herein; and opposite end may also be referred to as ‘distal end’ interchangeably herein. Dashed lines schematically delineate the different rivet portions; rivet 60 is a solid, integral element. Press fit portion 64 has diameter d1 and length 65. Body portion 66 has diameter d2. Diameter d1 of press fit portion is at least equal to diameter d2 of body portion 66. In a particular aspect, diameter dl of press fit portion is greater than diameter d2 of body portion 66. In an example aspect, body portion 66 and upset portion 68 have the same diameter d2; this condition being true prior to any upsetting operation being performed. Body portion 66 and upset portion 68 include diameters that may be constant or tapered prior to upsetting. If tapered, the diameter of body portion and/or upset portion gradually decreases in the direction toward opposite end 70. After any upsetting operation, the diameter of upset portion 68 is greater than diameter d2 of body portion 66.

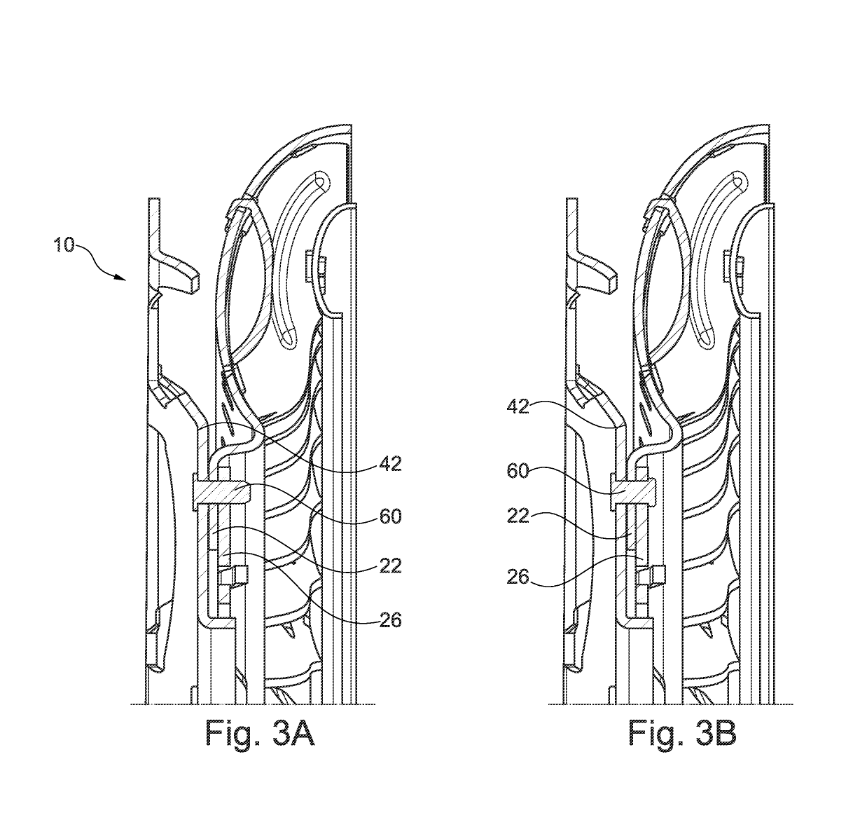

FIG. 3A illustrates a partial cross section side view of torque converter 10 showing the press fit rivet after press fitting but before upsetting according to an example aspect. Rivet 60 is press fit into damper cover plate 42. By press fit, we mean that the rivet is forcefully installed into the cover plate 42. In other words, rivet 60 cannot be installed into the cover plate without an external force, and, once installed, cannot be removed from the cover plate without a similar force. Turbine shell 22 and turbine hub 26 are assembled onto rivet 60 before upsetting. It should be noted that the shell and hub have a slip fit with the rivet so a forceful installation is not required. That is, once installed, body portion 66 has a radial clearance with a hole in each of the turbine shell 22 and turbine hub 26. FIG. 3B illustrates a partial cross section side view of torque converter 10 showing press fit rivet 60 after upsetting according to an example aspect. Note the orientation of rivet 60 wherein the preformed head 62 of rivet 60 is towards the damper.

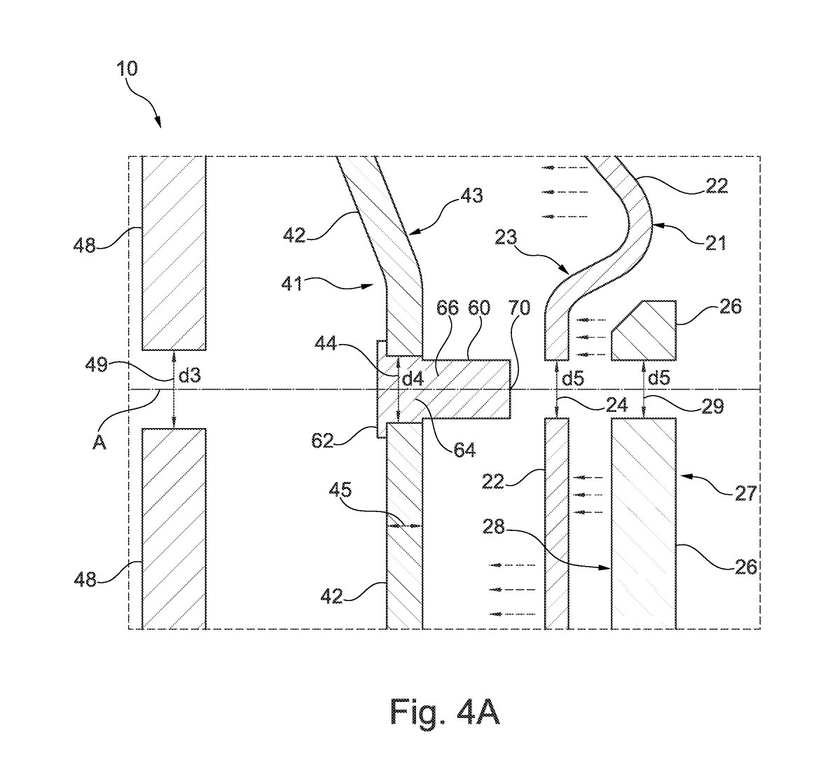

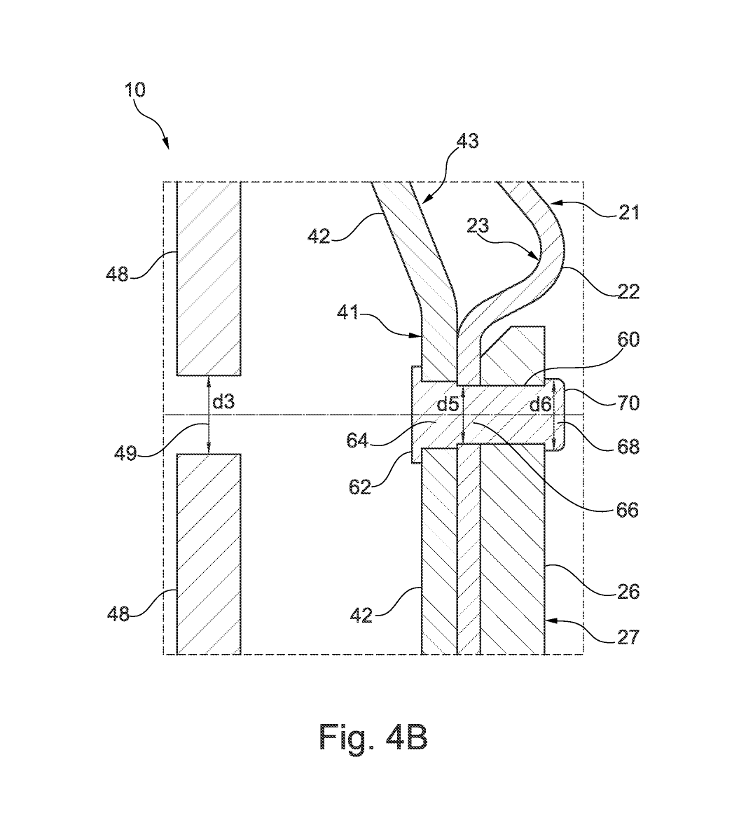

FIG. 4A illustrates an expanded cross sectional side view of torque converter 10 including damper assembly 40 after press fitting rivet 60 according to an example aspect. FIG. 4A shows the damper assembly before installing the turbine. The damper assembly comprises flange 48 including access hole 49 having a diameter d3. Access hole 49 may also be referred to, interchangeably herein, as ‘clearance hole’. Diameter d3 needs only to be large enough to allow access for support of rivet head 62 during rivet upsetting operation. Access hole 49 does not need to accommodate upsetting stripper and punch tools as in the prior art, therefore access hole 49 is relatively small. Press fit rivet 60 is press fit into damper cover plate 42 having inner surface 41, outer surface 43, hole 44 having diameter d4, and thickness 45. Rivet 60 further includes body portion 66, opposite end 70, and head 62 overlapping in a radial direction with inner surface 41 of cover plate 42. In an example aspect, damper assembly 40 may be preassembled to include press fit rivet 60.

In an example embodiment, press fit rivet 60 is disposed into cover plate hole 44 having diameter d4 using force so that press fit portion 64 fits snugly into hole 44. After press fitting operation, press fit portion 64 includes (i) a length (65 in FIG. 2) approximately same or equal to thickness 45 of cover plate 42 and (ii) a diameter approximately same or equal to diameter d4 of cover plate 42.

In an example aspect, as a result of the press fit operation, the diameter of press fit portion 64 is decreased. In other words, the original diameter dl of press fit portion is reduced. Prior to press fitting, press fit portion 64 includes diameter d1 (from FIG. 2) and diameter d1 is greater than damper cover plate hole diameter d4. In an example aspect, prior to press fitting, damper cover plate hole diameter d4 is at most equal to press fit portion diameter d1.

FIG. 4A illustrates the preassembled features of turbine shell 22 and turbine hub 26 before installing onto rivet 60. Arrows indicate movement of turbine shell and hub toward the damper assembly upon installation. Turbine shell includes inner surface 21, outer surface 23, and hole 24 having diameter d5. Diameter d5 is approximately same or equal to rivet body portion 66 having diameter d2 (FIG. 2). In an example aspect, body portion diameter d2 is at most equal to diameter d5 of hole 24. Turbine hub 26 includes inner surface 27, outer surface 28, and hole 29 having diameter d5. In an example aspect, the diameters of holes 24 and 29 are approximately the same or equal. Flange access hole 49, rivet 60 disposed in cover plate hole 44, turbine shell positioning hole 24, and turbine hub hole 29 are all aligned with axis A.

FIG. 4B illustrates an expanded cross sectional side view of torque converter 10 showing press fit rivet 60 after upsetting according to an example aspect. Torque converter 10 comprises damper assembly 40 including flange 48, cover plate 42, and rivet 60, and further including turbine shell 22 and turbine hub 26, each having a hole to receive rivet 60. Turbine shell 22 includes inner surface 21, outer surface 23, and hole 24 having diameter d5 (see also FIG. 4A). Hole 24 is also referred to interchangeably herein as ‘positioning hole’. Diameter d5 of turbine shell hole 24 is at most equal to body portion diameter d2 (from FIG. 2) of press fit rivet 60. In a particular aspect, d5 is greater than d2 for ease in assembly. That is, turbine shell hole 24 has a slip fit with rivet body portion 66. Turbine hub 26 includes inner surface 27, outer surface 28, and hole 29, also having diameter d5. Turbine hub hole 29 may also be referred to interchangeably herein as ‘opening’. Turbine hub hole 29 also has a slip fit with rivet body portion 66. The upsetting operation ensures that plate 42, shell 22, and hub 26 are fixedly attached or connected wherein the diameter d6 (after upsetting) of upset portion 68 is greater than any of the holes 44, 24, 29 in which rivet 60 was received; therefore, upset diameter d6 is greater than plate hole diameter d4 and shell hole diameter d5. That is, upsetting radially expands body portion 66 to fit tightly in the turbine shell hole 24 and turbine hub hole 29, and radially expands upset portion 68 to a diameter d6 greater than that of any of the holes in which rivet 60 was received. The upsetting tools, such as punch and stripper, are positioned on the turbine side of rivet 60, toward opposite end 70, for ease of upsetting operation.

In an example aspect, damper assembly 40 for torque converter 10 comprises: cover plate 42 comprising hole 44 having a first diameter d4; press fit rivet 60 disposed in hole 44, the rivet including: rivet head 62 and press fit portion 64 having a second diameter d1; where prior to press fitting the rivet into the hole, the second diameter is greater than the first diameter. In an example aspect, the damper assembly includes flange 48 having access hole 49 aligned with rivet head 62. In an example aspect, cover plate 42 includes inner surface 41 and outer surface 43, and wherein rivet head 62 is disposed at inner surface 41. In an example aspect, the damper assembly connects to a torque converter including turbine 20 having turbine shell 22, wherein rivet 60 connects cover plate 42 and turbine shell 22. In an example aspect, the torque converter further comprises turbine hub 26, wherein rivet 60 connects cover plate 42, turbine shell 22, and turbine hub 26.

In an example aspect, torque converter 10 comprises: turbine 20 including shell 22 having first positioning hole 24 and first diameter d5; damper assembly 40 including: flange 48 including access hole 49; cover plate 42 disposed between turbine shell 20 and flange 48; cover plate 42 comprising a thickness 45 and second hole 44 with second diameter d4; and, press fit rivet 60 including: preformed head 62 aligned with flange access hole 49; press fit portion 64 extending from preformed head 62 and disposed in cover plate second hole 44, press fit portion 64 having a third diameter d1 equal to the second diameter and length 65 at most equal to the cover plate thickness 45; body portion 66 installed in the first and second holes and having fourth diameter d2 equal to the first diameter and at most equal to the second diameter; and, upset portion 64 disposed at a distal end 70 of press fit rivet 60 opposite preformed head 62 and having a fifth diameter d6 larger than the fourth diameter in the post-upsetting condition. In an example aspect, damper cover plate 42 includes inner surface 41 and outer surface 43, and wherein rivet head 62 is disposed at inner surface 41. In an example aspect, rivet 60 connects cover plate 42 and turbine shell 20. In an example aspect, torque converter 10 further comprises turbine hub 26, wherein rivet 60 connects cover plate 42, turbine shell 22, and turbine hub 26. In an example aspect, prior to press fitting the rivet into the hole, upset portion 64 has a diameter at most equal to second diameter d4.

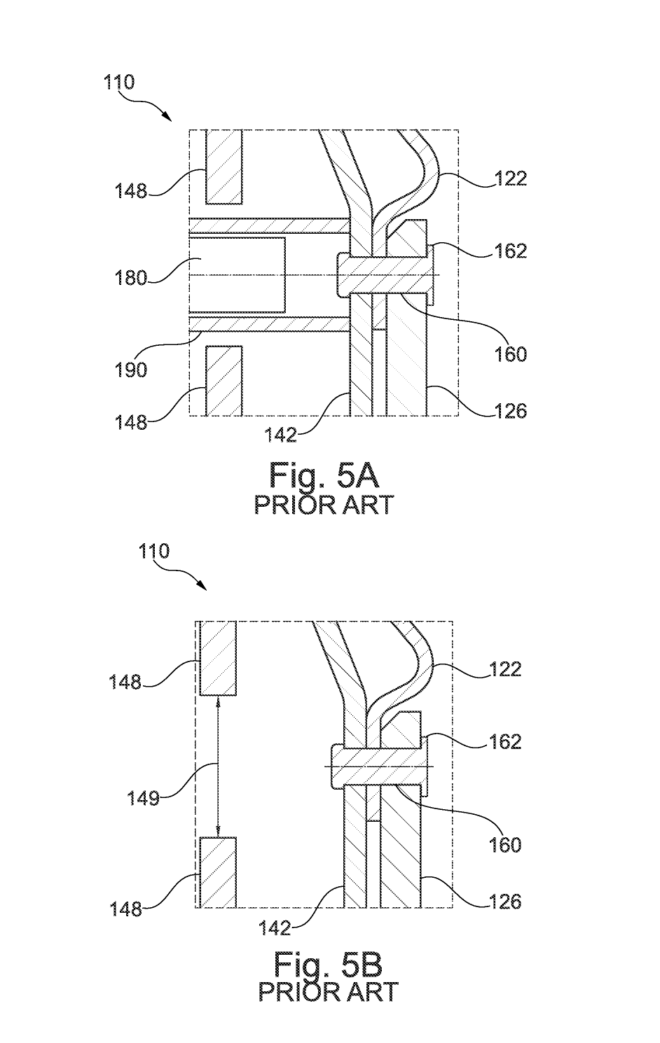

FIG. 5 illustrates cross sectional side views of a conventional rivet in a torque converter according to the prior art: (5A) upsetting tools shown and (5B) flange access hole shown. Torque converter 110 does not employ a press fit rivet. Torque converter 110 employs a conventional rivet oriented in the standard manner wherein the rivet head is towards the turbine. Upsetting tools punch 180 and stripper 190 must be accommodated to fit within the damper assembly to upset rivet 160. Flange 148 has hole 149 having a diameter that is greater than the outer diameter of stripper 190. Torque converter 110 includes damper cover plate 142, turbine shell 122, turbine hub 126, and rivet 160 including rivet head 162.

In an example aspect, a method of connecting a damper assembly and a turbine for a torque converter is provided. Referring to FIGS. 1-5, the method comprises: (i) providing press fit rivet 60 having: rivet head 62, press fit portion 64 having a first diameter d1, body portion 66 having second diameter d2, where the second diameter is at most equal to the first diameter; upset portion 68, and opposite or distal end 70; (ii) providing damper assembly 40 including cover plate 42 having hole 44 having a third diameter d4, where the third diameter is less than the first diameter; (iii) press fitting press fit portion 64 of rivet 60 into hole 42; providing turbine 20 including turbine shell 22 having positioning hole 24 having a fourth diameter d5; where the fourth diameter is at least equal to or greater than the second diameter; (iv) aligning and assembling positioning hole 24 of the turbine shell onto rivet 60; and (v) expanding upset portion 68 of the rivet into positioning hole 24 by upsetting opposite end 70 of rivet 60. Advantageously, in an example aspect, the method provides that rivet head 62 is disposed toward the damper 40 and the upsetting operation is disposed toward turbine 20.

In an example aspect, the method includes a damper assembly including flange 48 having access hole 49, and where step (ii) of providing a damper assembly further includes aligning flange access hole 49 with rivet head 62 about an axis A. In an example aspect, access hole 49 need only be large enough to accommodate a support for the rivet head. Advantageously, due to the small flange access hole, larger damper size is afforded in an example aspect. Upsetting tools, requiring more clearance, are not inserted into the flange access hole. In an example aspect, the method includes where step (ii) of providing a damper assembly further includes assembling the damper assembly including springs 46, radially outward springs 47, damper flange 48, damper cover plate 42, and outer sheet metal rivets 51.

In an example aspect, the method includes where cover plate 42 includes inner surface 41 and outer surface 43, and wherein rivet head 62 is disposed at inner surface 41. Advantageously, the rivet head is disposed toward the damper.

In an example aspect, the method includes where step (iv) of aligning and assembling further includes providing turbine hub 26 having opening 29, and aligning and positioning opening of the turbine hub onto the rivet prior to the step of expanding.

In an example aspect, the method includes where step (v) of expanding upset portion 68 of rivet 60 includes providing upsetting punch and stripper tools and positioning the upsetting tools over opposite end 70 of the rivet prior to upsetting.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

### LISTING OF ELEMENTS

A axis
10 torque converter
11 stud
12 front cover
14 piston plate
16 impeller shell, rear cover
18 impeller
20 turbine
21 inner surface of turbine shell
22 turbine shell
23 outer surface of turbine shell
24 positioning hole, turbine shell, d=d5
26 turbine hub
27 inner surface of turbine hub
28 outer surface of turbine hub
29 opening, turbine hub hole, d=d5
30 one-way clutch
32 stator
34 stator base
36 side plate
38 clutch plate
40 damper assembly
41 inner surface of cover plate
42 cover plate
43 outer surface of cover plate
44 hole, cover plate, d=d4
45 cover plate thickness
46 springs
47 radially outward springs
48 damper flange
49 flange access hole, d=d3
50 cover plate
51 outer sheet metal rivet
52 cover plate
54 drive plate
56 damper hub
58 leaf springs
60 press fit rivet
62 head portion, preformed head
64 press fit portion, d=d1
65 length of press fit portion
66 body portion, d=d2
68 upset portion, d=d2 before upsetting, d=d6 after upsetting
70 opposite end
86 bearings
88 inner race
90 cover pilot
92 roller for one-way clutch
110 torque converter, prior art
122 turbine shell
126 turbine hub
142 damper cover plate
148 damper flange
149 damper flange access hole
160 conventional rivet
162 rivet head
180 upsetting punch tool
190 upsetting stripper tool

What we claim is:

1. A damper assembly for a torque converter comprising:
a cover plate comprising a hole having a first diameter;
a press fit rivet disposed in the hole, the rivet including:
a rivet head; and,
a press fit portion having a second diameter;
where prior to press fitting the rivet into the hole, the second diameter is greater than the first diameter.

2. The damper assembly of claim 1 including a flange having an access hole aligned with the rivet head.

3. The damper assembly of claim 2 where the cover plate includes an inner surface facing the flange and an outer surface opposite the inner surface, and wherein the rivet head is disposed at the inner surface.

4. A torque converter comprising the damper assembly of claim 1 and a turbine having a turbine shell, wherein the rivet connects the cover plate and the turbine shell.

5. The torque converter of claim 4 further comprising a turbine hub, wherein the rivet connects the cover plate, the turbine shell, and the turbine hub.

6. A torque converter comprising:
a turbine including a shell having a first hole and a first diameter;
a damper assembly including:
a flange including an access hole;
a cover plate disposed between the turbine shell and the flange; the cover plate comprising a thickness and a second hole with a second diameter; and,
a press fit rivet including:
a preformed head aligned with the flange access hole;
a press fit portion extending from the preformed head and disposed in the cover plate second hole, the press fit portion having a third diameter equal to the second diameter and a length at most equal to the cover plate thickness;
a body portion installed in the first hole and having a fourth diameter equal to the first diameter and at most equal to the second diameter; and,
an upset portion disposed at a distal end of the press fit rivet opposite the preformed head and having a fifth diameter larger than the fourth diameter.

7. The torque converter of claim 6, where the damper cover plate includes an inner surface and an outer surface, and wherein the rivet head is disposed at the inner surface.

8. The torque converter of claim 6, wherein the rivet connects the cover plate and the turbine shell.

9. The torque converter of claim 8 further comprising a turbine hub, wherein the rivet connects the cover plate, the turbine shell, and the turbine hub.

10. The torque converter of claim 6, where prior to press fitting the rivet into the hole, the upset portion has a diameter at most equal to the second diameter.

11. A method of connecting a damper assembly and a turbine for a torque converter comprising:
providing a press fit rivet having:
a rivet head,
a press fit portion having a first diameter,
a body portion having a second diameter, where the second diameter is at most equal to the first diameter;
an upset portion, and
an opposite end;
providing a damper assembly including a cover plate having a hole having a third diameter, where the third diameter is less than the first diameter;
press fitting the press fit portion of the rivet into the hole;
providing a turbine including a turbine shell having a positioning hole having a fourth diameter; where the fourth diameter is at least equal to or greater than the second diameter;
aligning and assembling the positioning hole of the turbine shell onto the rivet; and
expanding the upset portion of the rivet into the positioning hole by upsetting the opposite end of the rivet.

12. The method of claim 11, where the damper assembly further includes a flange having an access hole, and the step of providing a damper assembly further includes aligning the flange access hole with the rivet head.

13. The method of claim 11, where the cover plate includes an inner surface and an outer surface, and wherein the rivet head is disposed at the inner surface.

14. The method of claim 11, where the step of aligning and assembling further comprises providing a turbine hub having an opening, and aligning and positioning the opening of the turbine hub onto the rivet prior to the step of expanding.

15. The method of claim 11, where the step of expanding the upset portion of the rivet includes providing upsetting punch and stripper tools and positioning the upsetting tools over the opposite end of the rivet prior to upsetting.

16. The method of claim 12, where the step of providing a damper assembly further includes assembling the damper assembly including springs, radially outward springs, the damper flange, the damper cover plate, and outer sheet metal rivets.
